(19) United States
(12) Patent Application Publication
(10) Pub. No.: US 2012/0137892 A1
(43) Pub. Date: Jun. 7, 2012

(54) DRINKS MACHINE

(75) Inventors: Sander Dollner, Ulm-Wiblingen (DE); Alexander Kiefer, Kuchen (DE); Armin Startz, Weidenstetten (DE)

(73) Assignee: WMF WUERTTEMBERGISCHE METALLWARENFABRIK AG, Geislingen/Steige (DE)

(21) Appl. No.: 13/307,114

(22) Filed: Nov. 30, 2011

(30) Foreign Application Priority Data
Dec. 3, 2010 (DE) 10 2010 062 398.9

(51) Int. Cl. A47J 31/44

(52) U.S. Cl. 99/280

(57) ABSTRACT

A drinks machine, such as a coffee machine, has at least one pipe, a container, a control device, a signal receiver, and at least one sensor to detect temperature. The at least one sensor is formed for wireless data transmission.

### BACKGROUND OF THE INVENTION

1. Field of the Invention

The present invention relates to a drinks machine with at least one senor for detecting conditions, such as temperature.

2. Description of the Related Art

Drinks machines and particularly coffee machines comprise numerous sensors detecting conditions, such as a temperature at a steam lance and transmitting it to a control device. The currently used sensors are generally formed as thermocouples or as NTC sensors and wired up. Applying the known sensors in removable components, for instance at a water tank or a milk storage tank places high requirements on the coupling or the design of the measuring point, in order to obtain precise and reproducible measurement results.

The present invention therefore deals with the problem of indicating an improved or at least alternative embodiment for a generic drinks machine, which is particularly constructed easily and at the same time permits to precisely detect the temperature.

### SUMMARY OF THE INVENTION

The present invention is based on the general idea of using a sensor capable of wireless data transmission for detecting a temperature in a drinks machine, for instance a sensor formed as a RFID chip and of integrating it into a wall of a pipe or of a container in which the fluid, for instance water or milk, whose temperature is to be detected, flows/is. Such a RFID chip, particularly operating capacitively is capable of wireless signal transmission to a control device and thus can be directly arranged at the measurement point and be used particularly to control frothing processes at the same time. Furthermore, by integrating it into a wall of the pipe or the container, it is at least partially covered and protected by a layer of material and can thus be particularly also be integrated into removable components, as for instance a milk frother or a milk container. The sensor formed as a RFID chip can measure the temperature without contact through a thin layer of the pipe or the container covering it, particularly of the milk frother in situ and transmit it in a wireless/contactless manner to the above mentioned control device. In this case, the customer can just remove the milk frother and clean it, even in the dish washer, without having to be afraid of so damaging the RFID chip. By using the code of the RFID chip, it is possible to directly detect whether the milk frother was mounted and particularly also whether the right milk frother was mounted. For instance, it is imaginable here to use different milk frothers, e.g. a power frother and a normal frother, which can be easily identified via the RFID chip whereupon with this information, the corresponding parameters, for instance a quantity of air, can be adapted accordingly. It is particularly advantageous in such a sensor formed as a RFID chip that it does not need any energy supply by a wire, but that it obtains the operational energy by high frequent electromagnetic waves. An internal wiring in the drinks machine can thus be avoided.

Evidently, the at least one senor can be arranged in the drinks machine or also in other peripherals, such as side coolers or containers, thermos flasks, bags, transport containers, the milk pot, frothing pot etc. In particular, it is imaginable here that the at least one sensor is arranged near a water tank or a milk tank and in this position cannot only detect the temperature of the water or the milk, but rather also a filling level of the container. By preferably completely embedding the at least one sensor in a material of the container or the pipe, it can for instance be molded with plastic during the production of the container and thus has a particularly protected position. The hidden position offers furthermore another big advantage, i.e. that the sensor does not have to meet higher hygiene requirements as it is not in direct contact with the milk or water or another type of food.

With the temperature sensor formed as a RFID chip according to the invention, particularly also the output temperature or the frothing quality at milk frothers can be improved, as such a senor, if it is arranged directly on a frothing head, is capable of measuring the current temperature there and to transmit it directly to a control device, which then adjusts the frothing process. With conventional sensors, such as thermocouples or NTC sensors, measuring the temperature directly at the frothing head is not possible or very difficult, as on the one hand, a wiring would be needed there and on the other hand the NTC sensor or also the thermocouple would be exposed to high hygienic requirements, as it would be in direct contact with the milk. Furthermore, in particular this area is generally cleaned by the user himself/herself, so it is developed to be removable, which also makes using currently known sensors more difficult. Also, particularly the frothing head is not only removed by the user, but also partially disassembled, which would lead to a high failure rate with externally arranged temperature sensors of previous design. By integrating the temperature sensor formed as a RFID chip according to the invention into a wall of the container or in a wall of the frothing head, it can be arranged in an extremely protected manner and thus resists even mechanical and/or chemical stress, as caused for instance by the user's cleaning.

With the temperature sensor formed as a RFID chip according to the invention which is furthermore an integral component of a container or a frothing head of a milk frother or a pipe, it is not only possible to reliably and precisely measure the temperature, but besides a relatively high functional safety is guaranteed as the sensor is arranged in a protected manner. Obviously, the temperature sensor formed as a RFID chip is not only limited to its being arranged in a container, in a pipe or in the frothing head of the milk frother, but can rather be also arranged on other positions in a coffee or drinks machine which have been difficult to reach for previous wired sensors.

Generally, the at least one sensor can be formed as an active or passive RFID chip, wherein active means that the sensor is provided with its own energy source, for instance a battery. Also, the at least one sensor can be provided with a data memory, in which for instance after switching off the drinks machine, a temperature curve is saved. Furthermore, the at least one sensor can be formed to detect at least one other parameter, as for instance pressure, distance, density or humidity, thus considerably enlarging the range of application.

Thus, the sensor does not necessarily have to be arranged in the drinks machine itself, but can also be arranged in a peripheral, such as a side cooler.

### BRIEF DESCRIPTION OF THE DRAWING

FIG. 1 is a schematic illustration of a drinks machine in accordance with the invention.

### DETAILED DESCRIPTION OF THE PREFERRED EMBODIMENT

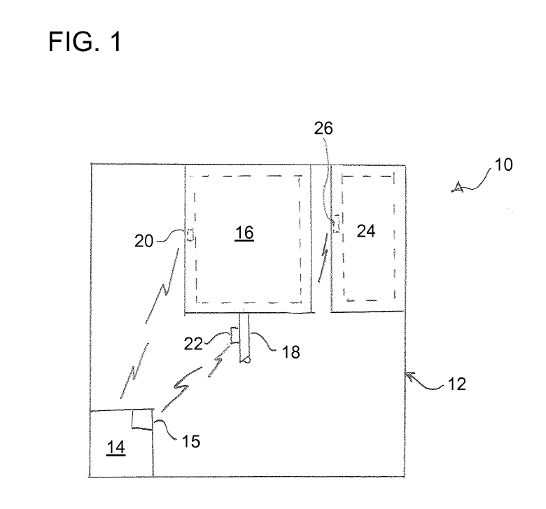

A drinks machine in accordance with the invention is embodied as a coffee machine and is identified by the reference numeral 10 in FIG. 1. The coffee machine 10 includes a housing 12 that encloses a plurality of operating components that may include at least one heater, at least one pump, a dispenser, an input device and a display, none of which are shown, and all of which may be of conventional design. More significantly, the housing 12 includes a control unit 14 with a signal receiver 15 that has the capability of generating and/or receiving control signals wirelessly.

At least one container 16 is mounted in the housing 12 and may be configured for storing water, milk or the like. At least one pipe 18 communicates with the container 16 and may further communicate with a dispenser (not shown). The container 16 may be molded unitarily from a synthetic resin and includes an array of interconnected walls. At least one sensor 20 is disposed in fixed relationship on or adjacent the container 16. More particularly, the sensor 20 preferably is an insert in a wall of the container 16 that is formed by an insert molding process. Thus, the sensor 20 is positioned accurately and is protected from liquids that may be used in or near the container 16. A sensor 22 also may be disposed adjacent the pipe 18. The sensors 20 and 22 preferably are RFID devices or include RFID devices that are capable of communicating wirelessly with the control unit 14. The sensor 20 may be operative to transmit data relating to temperature within the container 16, while the sensor 22 may be operative to transmit data relating to temperature within the pipe 18. The temperature data is transmitted wirelessly to the control unit 14. The control unit 14 then maybe operative to control other parts of the coffee machine 10, either wirelessly or via wires, based on the signals communicated wirelessly from the sensors 20 and 22.

The coffee machine 10 may further include a peripheral device, such as a side cooler 24 that may be used, for example, to store milk used in the preparation of cappuccino or hot cocoa. The side cooler 24 may include a sensor 26 incorporated into a wall thereof and configured to communicate wirelessly with the control unit 14. The sensor 26 may be configured for transmitting data relating to temperature within the side cooler 24.

The sensors 20, 22 and 26 are described as being operative for sensing or communicating temperature data. However, sensors for other purposes may be provided, including sensors for detecting pressure, density, humidity or proximity.

What is claimed is:

1. A drinks machine, comprising: at least a pipe, a container, a control device, a signal receiver and at least one sensor to detect the temperature, wherein the at least one sensor is formed for wireless data transmission.

2. The drinks machine according to claim 1, wherein the at least one sensor is arranged near a pipe containing water or milk.

3. The drinks machine of claim 1, wherein the at least one sensor is arranged near a container that can be arranged in the drinks machine.

4. The drinks machine of claim 3, wherein the container is a water tank, a milk tank, a milk concentrate container, a bag, a transport container, a milk pot, a frothing pot, or a thermos flask.

5. The drinks machine of claim 3, wherein the at least one sensor is completely embedded in a material of the container or the pipe.

6. The drinks machine of claim 5, wherein the at least one sensor is formed to identify the container in which the sensor is embedded.

7. The drinks machine of claim 1, wherein the at least one sensor is a RFID chip (Radio Frequency Identification) integrated into a wall of the pipe or of the container.

8. The drinks machine of claim 7, wherein the at least one sensor is an active or passive RFID chip.

9. The drinks machine of claim 1, wherein the at least one sensor is provided with a data memory.

10. The drinks machine of claim 1, wherein the at least one sensor further is formed to detect at least one of pressure, distance, density and humidity.

11. The drinks machine of claim 1, further comprising a side cooler in which the sensor is arranged.
